(19) United States
(12) Patent Application Publication
(10) Pub. No.: US 2008/0270373 A1
(43) Pub. Date: Oct. 30, 2008

(54) Method and Apparatus for Content Item Signature Matching

(75) Inventors: Job Cornelis Oostveen, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,199

(22) PCT Filed: May 23, 2005
(86) PCT No.: PCT/IB05/51673

§ 371 Date: Nov. 16, 2006

(30) Foreign Application Priority Data
May 28, 2004 (EP) 04102377.1

(51) Int. Cl. G06F 17/30

(52) U.S. Cl. 707/5; 707/E17.017

(57) ABSTRACT

An apparatus for content item signature matching comprises a database (103) which has signatures for a plurality of content items. A likelihood processor (105) determines a match likelihood indication for the content items where the match likelihood indication is indicative of a likelihood of a match between the content item and an unknown signature. An interface (111) receives a query signature associated with a content item and in response a search processor (113) searches the database (103) for a matching signature to the query signature. The search processor (113) is operable to search the database in response to the match likelihood indication of the plurality of content items. In particular the database (103) may be ordered in order of decreasing probability of a match and the search processor (113) may search the database in this order. Hence, the probability of an early match is increased and the average search time is reduced.

### FIELD OF THE INVENTION

The invention relates to a method and apparatus for content item signature matching and in particular, but not exclusively, to finding a matching fingerprint in a database.

### BACKGROUND OF THE INVENTION

The illicit distribution of copyright material deprives the holder of the copyright the legitimate royalties for this material, and could provide the supplier of this illicitly distributed material with gains that encourages continued illicit distributions. In light of the ease of transfer provided by e.g. the Internet, content material that is intended to be copyright protected, such as artistic renderings or other material having limited distribution rights are susceptible to wide-scale illicit distribution.

In particular, content items such as music or video items are currently attracting a significant amount of unauthorized distribution and copying. This is partly due to the increasing practicality and feasibility of distribution and copying provided by new technologies. For example, the MP3 format for storing and transmitting compressed audio files has made a wide-scale distribution of audio recordings feasible. For instance, a 30 or 40 megabyte digital PCM (Pulse Code Modulation) audio recording of a song can be compressed into a 3 or 4 megabyte MP3 file. The introduction of broadband internet connections stimulates the download of even bigger files such as MPEG video. The illicit copy of the MP3 encoded song can be subsequently rendered by software or hardware devices or can be decompressed and stored on a recordable CD for playback on a conventional CD player.

A number of techniques have been proposed for limiting and tracking the reproduction of copy-protected content material. The Secure Digital Music Initiative (SDMI) and others advocate the use of “digital watermarks” to prevent unauthorized copying.

Digital watermarks can be used for copy protection according to the scenarios mentioned above. However, the use of digital watermarks is not limited to copy prevention but can also be used for so-called forensic tracking, where watermarks are embedded in e.g. files distributed via an Electronic Content Delivery System, and used to track for instance illegally copied content on the Internet. Watermarks can furthermore be used for monitoring broadcast stations (e.g. commercials); or for authentication purposes etc.

Another technique which is suitable for detection and recognition of content items is known as fingerprint techniques. In contrast to watermarking, the content signals are not modified by introduction of a specific watermark pattern but rather a substantially unique characteristic for the content item is determined and used for identification.

As an example, data related to a number of content items may be stored in a database and fingerprint techniques may be used to find a content item matching a given unknown content item. The approach typically includes the following steps:

1. Fingerprints (typically short digital representations) of the known content items are computed based on the content items and are stored in a database together with associated metadata. The metadata may for example correspond to an identity of the content.
2. Upon reception of a query (typically an unknown content item), a fingerprint is computed and compared with the stored fingerprints.
3. If the fingerprint of the unknown content matches one of the fingerprints in the database sufficiently closely, the metadata is returned in response to the query. Specifically, the method may return the identity of the content item.

An identification of content items may be useful in many applications including content item tracking and rights management and policing.

For many applications, the database will be a large, central server with which clients (such as decentralized monitoring stations, cell-phones, personal computers etc) communicate in order to identify some unknown content. Some applications, however, do not have a central database. For instance, a hard-disk video recorder might have a database with fingerprints of all material it has stored locally. It might use the fingerprint technology to prevent duplicate recordings.

A crucial problem for fingerprinting is that the best match needs to be found in the database. In general this is a difficult problem, as the query content item may not be exactly identical to the content items of the stored fingerprint. For example, compression and noise may cause differences that will also result in the query fingerprint not being identical to the stored fingerprint for the matching content item. Accordingly, a match is typically determined to occur if a distance measure between the query fingerprint and the stored fingerprint is below a given value. The distance measure may be relatively complex to determine and the reliability and accuracy of the process depends closely on the characteristics of the distance measure used.

Moreover, the databases may be extremely large. For instance, a database of all songs which are regularly played on one of the radio channels in the USA, would contain the fingerprints of in the order of one million songs. Therefore, the complexity and duration of the matching process should preferably be minimized and should not increase drastically with increasing database sizes.

An example of a scalable database architecture for fingerprints is given in Patent Cooperation Treaty Patent Application WO 02/065782. In this, the computational complexity of searching is reduced in exchange for an increased memory requirement. More precisely, an index is added to allow fast access determination of candidate matching locations. Although an efficient scaling of search speed and complexity is achieved, the required memory overhead may be disadvantageous or unacceptable in many applications such as in applications that do not utilize a central database.

Most fingerprint or watermark matching algorithms simply start at the beginning of the database and sequentially and exhaustively search through the database. Some techniques may be employed to facilitate or accelerate such a search. In particular pruning techniques may be used to speed up the algorithm. Pruning techniques are used to designate large subsets of the database as impossible locations for a sufficiently close match thereby allowing the search algorithm to bypass these locations. A number of entries in the database are so-called anchors. For each entry in the database, the distance to the anchors is pre-computed. When a query is submitted to the database, its distance to the anchors is computed. If the distance between an anchor and the query is sufficiently large, then all points near to the anchor will also have a high distance and therefore cannot be a match. Accordingly, the neighborhood of that anchor does not need to be searched and can be pruned away.

Although pruning does increase the search speed, the improvement is not always sufficient. In addition, pruning adds to the cost and complexity of the system since the distances to all anchor points need to be stored for each entry.

Hence, an improved system for content item signature matching would be advantageous and in particular a system allowing increased flexibility, reduced complexity and/or reduced search duration would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided an apparatus for content item signature matching comprising: a database comprising signatures for a plurality of content items; means for determining a match likelihood indication for each of the plurality of content items, the match likelihood indication of each content item being indicative of a likelihood of a match between the content item and an unknown signature; means for receiving a query signature associated with a content item; search means for searching the database for a matching signature to the query signature; and wherein the search means is operable to search the database in response to the match likelihood indication of the plurality of content items.

The invention may allow a more flexible content item signature matching algorithm which takes into account a likelihood of a match occurring for the signatures stored in a database. The invention may allow for a reduced search time and may in particular reduce the average time before a match for a query signature is determined A reduced complexity may be achieved and in particular the invention may allow improved search speed without requiring additional information to be stored or resulting in increased memory requirements.

The match likelihood indication may specifically indicate a probability that a query signature will match the signature of the content item associated with the match likelihood indication. Preferably, the search means searches the database in order of reducing probability of the stored signatures being a suitable match.

The database may preferably store the signatures of the plurality of content items but may additionally or alternatively store the content items themselves. The search means may for each content item determine the signature during the search but preferably the search means use a stored signature that has been pre-calculated.

The content item signature may specifically be a characteristic or parameter suitable for identification of the content item such as a watermark or a fingerprint of the content item.

The receiving means may receive the query signature from an internal or external source.

According to a preferred feature of the invention, the apparatus further comprises means for ordering the signatures of the plurality of content items in the database in response to the match likelihood indication; and the search means is operable to search the database in accordance with the ordering of the signatures of the plurality of content items.

In particular the database may be ordered sequentially by ordering the signatures in order of decreasing match likelihood. Hence, the search means may search the stored signatures in order of decreasing match likelihood simply by moving sequentially through the database. The database may alternatively be ordered e.g. in a tree structure. The feature may provide a suitable implementation and may in particular facilitate the search and thus the content item signature matching operation.

According to a preferred feature of the invention, the means for determining the match likelihood indication is operable to determine the match likelihood indication in response to a previous match count for each signature of at least some of the plurality of content items.

For example, the match likelihood indication may indicate a higher likelihood for an increasing number of previous matches for the stored signature. In particular, the match likelihood indication may consist in a match count for each content item thus resulting in a search operation ordered in response to this characteristic. The search means may search the database in order of the number of previous matches for signatures. Thus, signatures that have matched many previous queries may be searched before signatures that have not resulted in many previous matches. The feature is in some embodiments particularly advantageous for controlling the search to provide an improved signature matching operation and in particular to achieve a reduced search time.

According to a preferred feature of the invention, the means for determining the match likelihood indication is operable to determine the match likelihood indication in response to a database entry time for each signature of the plurality of content items.

For example, the match likelihood indication may indicate a decreasing likelihood for an increasing duration since the entry time of the signature. The entry time may in particular be the time at which the signature or content item was stored (or updated) in the database. In particular, the match likelihood indication may consist in an entry time for each content item thus resulting in a search operation ordered in response to this characteristic. The search means may search the database in order of the entry time. Thus, signatures that have recently been stored in the database may be searched before signatures that have been stored some time ago. The feature is in some embodiments particularly advantageous for controlling the search to provide an improved signature matching operation and in particular to achieve a reduced search time.

According to a preferred feature of the invention, the means for determining the match likelihood indication is operable to determine the match likelihood indication in response to a previous time of match for each signature of the plurality of content items.

For example, the match likelihood indication may indicate a decreasing likelihood for an increasing duration since the signature provided a match to a query. The previous time of match may in particular be the time at which the signature or content item matched a query. In particular, the match likelihood indication may consist in a previous time of match for each content item thus resulting in a search operation ordered in response to this characteristic. The search means may search the database in order of the previous match time. Thus, signatures that have recently provided a match may be searched before signatures that have not provided a match for some time. The feature is in some embodiments particularly advantageous for controlling the search to provide an improved signature matching operation and in particular to achieve a reduced search time.

According to a preferred feature of the invention, the means for determining the match likelihood indication is operable to determine the match likelihood indication in response to metadata associated with each of the plurality of content items.

For example, the match likelihood indication may indicate a likelihood which depends on the associated metadata. The metadata may indicate further information about the content item which can be used to indicate a probability of a match. For example, a match likelihood indication may be determined which has a high likelihood for metadata indicating that the content item is a music content item and a low likelihood for metadata indicating that the content item is a voice only content item. In a music signature match application wherein there is a high probability that the query signature is for a music content item, the search means may first search the stored music content items before the stored voice only content items. In some embodiments, the match likelihood indication may be interpreted in response to the query. For example, if a voice only signature is received the match likelihood indication may instead be considered high for the voice only content items and low for the music content item.

The feature is in some embodiments particularly advantageous for controlling the search to provide an improved signature matching operation and in particular to achieve a reduced search time.

According to a preferred feature of the invention, the means for determining the match likelihood indication is operable to determine the match likelihood indication in response to context information associated with each of the plurality of content items.

For example, the match likelihood indication may indicate a likelihood that depends on the context information of the content item. The context information may relate to external characteristics associated with the content item such as a means of distribution, a source, a time of distribution, a transmission format, an association with other content items etc.

The context information may thus indicate additional information related to the content item which can be used to indicate a probability of a match. For example, a match likelihood indication may be determined that has a high likelihood for context information indicating that the content item is from a TV broadcast and a low likelihood for context information indicating that the content item is from a video camera. In a TV clip signature match application wherein there is a high probability that the query signature is for a TV clip, the search means may first search the stored TV content items before the stored video camera content items. In some embodiments, the match likelihood indication may be interpreted in response to the query.

The feature is in some embodiments particularly advantageous for controlling the search to provide an improved signature matching operation and in particular to achieve a reduced search time.

According to a preferred feature of the invention, the means for determining the match likelihood indication is operable to determine the match likelihood indication in response to content information associated with each of the plurality of content items.

For example, the match likelihood indication may indicate a likelihood which depends on the content information of the content item. The content information may relate to characteristics associated with the content of the content item such as a genre, color saturation, scene change speed etc.

The content information may thus indicate additional information related to the content item which can be used to indicate a probability of a match. For example, a match likelihood indication may be determined which has a high likelihood for content information indicating that the content item is a cartoon, and a low likelihood for content information indicating that the content item is a football match. In a children's content item signature match application there is a high probability of the query signature being for a cartoon, and accordingly the search means may first search the stored cartoon content items before the stored football content items. In some embodiments, the match likelihood indication may be interpreted in response to the query.

The feature is in some embodiments particularly advantageous for controlling the search to provide an improved signature matching operation and in particular to achieve a reduced search time.

According to a preferred feature of the invention, the apparatus further comprises means for determining the content information by content analysis. This may allow automatic content information determination and may be suitable for use with existing content items. It provides a practical and convenient way of determining content information.

According to a preferred feature of the invention, the match likelihood indication comprises a plurality of sub-match likelihood indications and the search means is operable to search the database hierarchically in response to the sub-match likelihood indications.

This may facilitate and speed up searching and may provide an increased probability of a correct match. The match likelihood indication may for example comprise sub-match likelihood indications in the form of a combination of some or all of the parameters disclosed above.

According to a preferred feature of the invention, the match likelihood indication comprises a plurality of sub-match likelihood indications and the search means (113) is operable to select a sub-match likelihood criterion in response to a characteristic of the query signature.

The match likelihood indication may comprise a plurality of sub-match likelihood indications for each content item and the search means may be operable to select a sub-match likelihood indication for each content item. The selection may for example be in response to a characteristic of the query signature or the content item associated therewith. Furthermore, a match likelihood indication may be interpreted in response to a characteristic of the query signature or the content item associated therewith. This may facilitate and speed up searching and may provide an increased probability of a correct match.

Preferably the query signature is a content item fingerprint. The signatures of the plurality of content items are preferably fingerprints of the plurality of content items. The invention may thus provide an improved means of determining a matching fingerprint for a query fingerprint.

According to a preferred feature of the invention, the matching signature is a matching fingerprint and the search means is operable to determine a matching fingerprint as a fingerprint of the plurality of content items having a difference measure relative to the query signature below a predetermined value. This may provide a particular suitable implementation providing fast and reliable content item fingerprint matching performance.

According to a preferred feature of the invention, the content item is an audiovisual content item. The audiovisual content item may in particular be an audio content item, such as an audio clip or a song, or a video clip with or without associated audio.

According to a preferred feature of the invention, the receiving means comprises means for receiving a content item and for determining the content item signature in response to the content item. This provides a practical implementation.

According to a second aspect of the invention, there is provided a method of content item signature matching in a database comprising signatures for a plurality of content items, the method comprising the steps of: determining a match likelihood indication for each of the plurality of content items, the match likelihood indication of each content item being indicative of a likelihood of a match between the content item and an unknown signature; receiving a query signature associated with a content item; searching the database for a matching signature to the query signature in response to the match likelihood indication of the signatures of the plurality of content items.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates an apparatus for content item signature matching in accordance with an embodiment of the invention.

### DESCRIPTION OF PREFERRED EMBODIMENTS

The following description focuses on an embodiment of the invention applicable to fingerprint matching for audiovisual content items but it will be appreciated that the invention is not limited to this application but may be applied to many other applications including watermark matching.

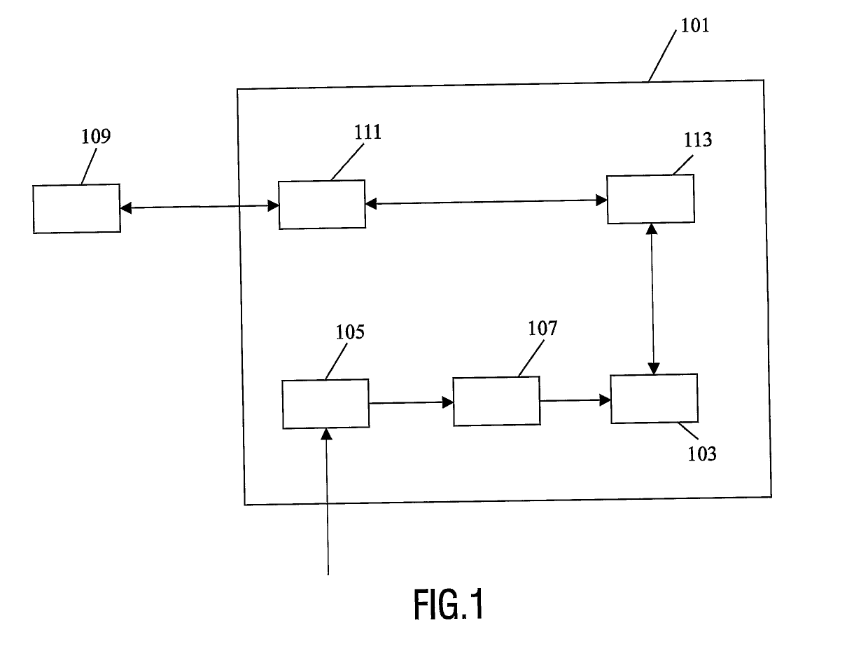

FIG. 1 illustrates an apparatus for content item signature matching in accordance with an embodiment of the invention.

The apparatus 101 comprises a database 103 which stores fingerprints for a plurality of audiovisual content items. As a specific example, the database may store fingerprints for a large number of music clips such as MP3 encoded songs. In the specific embodiment, the database stores a fingerprint and associated data for each content item. Any suitable associated data may be stored, and in the specific embodiment, the database stores at least the song title, the artist, the length, the album from which the song was taken and associated album cover art.

The apparatus further comprises a likelihood processor 105 which in the embodiment may receive a new content item for which to store information in the database 103. When the likelihood processor 105 receives a new content item to store in the database 103, it determines a match likelihood indication for the new content item. The match likelihood indication is an indication of the likelihood that the fingerprint of an unknown content item will match the fingerprint of the new content item. Any suitable criterion or algorithm for determining the match likelihood indication may be used without detracting from the invention, and a number of possible criteria will be described later.

The likelihood processor 105 is coupled to an ordering processor 107. The ordering processor 107 is further coupled to the database 103 and is operable to order the fingerprints of the plurality of content items in the database 103 in response to the match likelihood indication. In the specific embodiment, the ordering processor 107 receives the new fingerprint and match likelihood indication from the likelihood processor 105. In the example, the database 103 is ordered as a single sequential list of entries starting with the fingerprint having the highest match likelihood indication and ending with the fingerprint having the lowest match likelihood indication. The ordering processor 107 simply finds the location in the database wherein the match likelihood indication of the new fingerprint fits, i.e. where the match likelihood indication of the previous fingerprint is higher or equal to the match likelihood indication of the new fingerprint and the match likelihood indication of the following fingerprint is lower than or equal to the match likelihood indication of the current fingerprint. In addition, the ordering processor 107 stores the associated data received with the content item including the song title, artist name etc.

Thus, as content items are received, the database 103 is populated by fingerprints and associated data in a sequential list ordered in terms of decreasing probability of the fingerprint matching the fingerprint of an unknown content item.

It will be appreciated that the ordering of the database 103 is preferably a structural or logical ordering that may or may not correspond to a physical ordering in the memory containing the database. For example, if the database is stored on a hard disk, new fingerprints and associated data may be stored in the next available memory locations. The hard disk may in this case additionally comprise an ordered file allocation table that points to the physical location of each fingerprint. In this example, the file allocation table may thus be manipulated and ordered by the ordering processor 107 in response to the match likelihood indication, whereas the physical locations of the fingerprints may reflect the sequence in which the content items were received.

In the embodiment, the apparatus 101 is a central apparatus operable to identify content items by finding matching fingerprints in the database. In particular, an external source 109 may transmit a query to the apparatus 101 in response to which a matching fingerprint is determined in the database 103 resulting in the associated data for that content item being sent to the external source 109. The apparatus may for example be connected to the Internet and the external source may be a personal computer also coupled to the Internet. When a content item is played in the personal computer, this may determine a fingerprint of the content and transmit it to the apparatus 101. In response to this query, the apparatus transmits data of the song title, artist etc back to the personal computer which may display it to the user. Thus, in the specific example, the apparatus operates as a central server operable to provide information to distributed clients in response to queries transmitted from these.

Accordingly, the apparatus 101 comprises an interface 111 that receives a query fingerprint from the external source 109. The query fingerprint is derived from a content item, and specifically from a song, by the external source. The interface 111 is coupled to a search processor 113 and the query fingerprint is fed to the search processor 113.

The search processor 113 is further coupled to the database 103 and is operable to search the database 103 to find a matching fingerprint to the query fingerprint. In particular, the search processor 113 is operable to search the database 103 in response to the match likelihood indication of the content items.

In the example where the database is a single ordered sequential list, the search means simply processes the items sequentially. Thus, the search processor 113 first compares the query fingerprint with the first fingerprint of the database 103. If this does not result in a match, the search processor 113 proceeds to compare the query fingerprint to the next fingerprint in the list and so on. The search processor 113 proceeds until a match is found or until all fingerprints in the database have been evaluated.

It will be appreciated that any suitable means of determining if a match has occurred may be used. Typically, different versions of a content item, such as a song, are not identical. For example, different compression settings or noise may result in variations between the content item of the external source 109 and of the database 103 although these relate to the same song. Therefore, a match is preferably determined to occur when the query fingerprint is sufficiently close to the stored fingerprint but without requiring that they are identical. Preferably, a suitable distance measure is used such as the Hamming Distance for binary fingerprints, or Euclidian distance for non-binary fingerprints. When this distance measure applied to a fingerprint of the database 103 is below a given threshold, a match is deemed to have occurred.

When a matching fingerprint is found, the search processor 113 retrieves the associated data for that fingerprint and forwards it to the interface 111 which transmits it to the external source 109.

In the embodiment, the search processor 113 thus searches through the database 103 in response to the match likelihood indication of the stored fingerprints and in particular in order of decreasing probability of the stored fingerprint being a suitable match.

In a conventional approach, a search for a matching fingerprint would result in a random duration before the matching fingerprint was found, and thus the expected fraction of the database that would have to be searched before a sufficiently close match is found would be approximately 0.5. In the current embodiment, this may be significantly reduced as the most likely candidates are evaluated before the less likely candidates and accordingly the search time before a match is found may be substantially reduced. Furthermore, this advantage is achieved with a very simple implementation and the complexity of the apparatus and the search algorithm may be reduced in comparison to other fast search algorithms. Additionally, the embodiment allows a low memory resource requirement and in particular does not introduce any significant increase in the memory requirement.

Although the above description focused on an ordering of the database 103 in response to the match likelihood indication combined with a simple search in the ordered database 103, it will be appreciated that this is not essential and that for example a more complex search algorithm taking into account the match likelihood indication may alternatively or additionally be used with a non-ordered database.

It will also be appreciated that although the described embodiment for simplicity and clarity described a process of determining a match likelihood indication only for new content items, the apparatus may further be operable to iteratively and/or dynamically re-evaluate match likelihood indications of stored fingerprints and/or may re-order the database and/or the search algorithm accordingly. For example, the match likelihood indications of fingerprints may be updated and the database re-ordered in response to the match performance of the fingerprints.

In some embodiments, the interpretation of the match likelihood indication depends on the characteristics of the received query. For example, a fixed number of categories may be defined as possible values of a match likelihood indication. For each content item, it is determined in which of the defined categories the content item falls and the match likelihood indication for that content item is set accordingly. When a query is received, the search processor may determine which category the associated content item most probably belongs to, and may accordingly decide that this category of the match likelihood indication corresponds to a high probability of match whereas other categories are considered of lower likelihood. Accordingly, the fingerprints of the corresponding category are searched before other categories.

It will also be appreciated that the match likelihood indication may in some embodiments comprise a plurality of sub-indications. For example, a match likelihood indication may be generated in response to a plurality of different characteristics or assumptions. All the determined values may be stored as a composite match likelihood indication. The search processor 113 may in response to a specific category select one or more match likelihood indications and use these for ordering the search.

Examples of parameters and characteristics that may be taken into account when determining the match likelihood indication, or which may be used as a match likelihood indication, are described in the following. The described examples may be used in unity or together in any suitable combination or interrelation and may alternatively or additionally be used with other parameters or characteristics. Furthermore, the terms and examples provided below are mutually exclusive but may overlap and include common aspects, feature and advantages.

The match likelihood indication may be determined in response to a previous match count for each fingerprint of the plurality of content items. In many embodiments, the history of fingerprint matching may be the best predictor for future matches. Therefore, each fingerprint in the database may have an associated match counter that reflects how often the fingerprint has been found to be the best match (or at least a sufficiently close match) within a given previous time interval. At intervals, the ordering processor 107 may re-order the database to reflect the value of the match counters. Hence, the search processor 113 will search through the database 103 in the order of successful matches starting with the fingerprints that have matched many previous queries and ending with fingerprints that have only matched few or none previous queries.

The match likelihood indication may alternatively or additionally be determined in response to a database entry time for each fingerprint of the plurality of content items. In certain applications, the content items will have a limited life-time (among others, this is typically the case for commercials, news-clips and music-clips). Accordingly, the time and/or date of the fingerprint being entered into the database may be used to determine a suitable match likelihood indication. In particular, the date of entry in the database may in itself be an appropriate match likelihood indication useful for ordering the search and or database entries. Hence, when a query is submitted, this will be compared to the fingerprints in the order of the date of entry of these fingerprints in the database, preferably starting with the most recent and ending with the oldest content items.

The match likelihood indication may alternatively or additionally be determined in response to a previous time of a match for each fingerprint of the plurality of content items. For some applications, the interest in specific content items may vary cyclically. For instance in the case of news clips: certain events may refer to a historic event and thus lead to the broadcasting of old news clips concerning this historic event. In this case, the date of the last match is an appropriate characteristic for determining a match likelihood indication and may in particular be used directly as the match likelihood indication for ordering the database. For example, whenever a fingerprint in the database is found to be the best match to the current query, it is moved to the first position in the database ordering. Queries will be matched to the fingerprints in the database in the order of match date of the database fingerprints. Accordingly, a new query will first be compared to the matching fingerprint of the previous query.

The match likelihood indication may alternatively or additionally be determined in response to metadata associated with each of the plurality of content items. In many applications, metadata may be submitted with both the content items for which fingerprints are stored and the fingerprint query itself. Metadata may be auxiliary data, which is not required for recreating the content item, but which may provide additional information associated with the content item. This additional information may be suitable for determining a likelihood of a content item matching a query fingerprint. For example, the entries in the database may be ordered in response to a parameter of the metadata such as category data or genre data. When a query is received, the corresponding category or genre is determined and the stored fingerprints associated with the same category or genre are searched first.

The match likelihood indication may alternatively or additionally be determined in response to context information associated with each content item. For most applications the use of contextual information related to the content can be a powerful characteristic for ordering a search. The contextual information may be information which is not required to regenerate a presentation signal of the content item but which provides information related to conditions associated with the content item. For example, the context information may be related to a source of origin, a distribution characteristic or a target audience. As a specific example, context information for TV clips may include information indicating a source channel, day of the week (Monday, Tuesday, etc.), time of the day (e.g. morning, evening, night) etc. This additional context information may be suitable for determining a likelihood of a content item matching a query fingerprint. For example, the entries in the database may be ordered in response to a parameter of the context information and when a query is received, the corresponding fingerprints with the same characteristics may be searched first. In the specific example fingerprints from the same source channel, day and time will be searched first.

The match likelihood indication may alternatively or additionally be determined in response to content information associated with each of the plurality of content items.

Content information may be additional information related to the content of the source clips. The content information may be additional or auxiliary information included with the content item or may be determined from the content items by content analysis.

Typically, content analysis is based on detecting specific characteristics typical for a category of content. For example, a video content item may be detected as relating to a football match by having a high average concentration of green color and a frequent sideways motion. Cartoons are characterized by typically having strong primary colors, a high level of brightness and sharp color transitions.

Thus video coding parameters may advantageously be used to determine the content of a video signal. For example, a high relative value of AC coefficients in a DCT transform block indicates that a sharp transition is likely to be comprised in the transform block. Such a transition is typical for a cartoon and may therefore be included as a video coding parameter that indicates that the current content is a cartoon. Typically, a significant number of parameters are considered and the content may be determined as the content category which most closely correlates with the determined characteristics. Thus, the color saturation and luminance may further be included to determine if the current content is a cartoon. For example, if video coding data indicates a high degree of color saturation, high luminance, a high concentration of energy in high frequency DCT coefficients as well as large uniform or flat picture areas, a content analysis algorithm may determine the current content as a cartoon.

Another example of a video coding parameter that may be useful for content analysis is motion data such as motion vectors. For example, if an area of a picture comprises a very high degree of prediction with small associated motion vectors, this may be an indication that the picture is static for this area and thus that the content of this area is likely to be overlay text or an on-screen logo (e.g. a station logo).

Typically, both video coding parameters and non-video coding parameters may be used together for content analysis. For example, a high degree of motion, strong luminance and a rhythmic nature of an associated sound track may indicate that the current content is a music video.

Further information on content analysis is generally available to the person skilled in the art. For example, the articles “Content-Based Multimedia Indexing and Retrieval” by C. Djeraba, IEEE Multimedia, April-June 2002, Institute of Electrical and Electronic Engineers; “A Survey on Content-Based Retrieval for Multimedia Databases” by A. Yoshika et al., IEEE Transactions on Knowledge and Data Engineering, vol. 11, No. 1, January/February 1999, Institute of Electrical and Electronic Engineers; “Applications of Video-Content Analysis and Retrieval” by N. Dimitrova et al., IEEE Multimedia, July-September 2002, Institute of Electrical and Electronic Engineers and the therein included references provide an introduction to content analysis.

This additional content information may be suitable for determining a likelihood of a content item matching a query fingerprint. For example, the entries in the database may be ordered in response to a parameter of the content information and when a query is received, the corresponding fingerprints with the same characteristics may be searched first.

In the above described embodiment, the apparatus 101 receives a query fingerprint from the external source 109. However, it will be appreciated that in some embodiments, the apparatus may receive a query content item and the apparatus may determine a fingerprint in response to the received content item. Similarly, the fingerprints stored in the database may be determined by the apparatus or may be received from external means.

In the described embodiment, the fingerprints of content items are stored in the database rather than the content items themselves. However, in some embodiments, the content items may additionally or alternatively be stored in the database. For example, in some embodiments only the content items are stored in the database and the search processor is operable to generate a fingerprint for the stored content items when searching through the database. Such an embodiment may for example be suitable for providing fingerprint matching functionality to an existing database of content items that cannot be modified for technical or legal reasons.

It will be appreciated that in some embodiments, the match likelihood indication may comprise a plurality of sub-match likelihood indications. For example, match likelihood indication may comprise a sub-match likelihood indication indicating the genre of the content item, another sub-match likelihood indication indicating a time of transmission, a third sub-match likelihood indication indicating a content item source etc.

In this case the search processor 113 preferably searches the database hierarchically. In particular, it first searches the data base for the content items being of the same genre, then searches these content items to find the content items having similar transmission times and finally selects between these based on the content item source. Preferably, the data base is in this example ordered by the genre of the content items, then by the transmission time and finally by the content item source thereby providing for a very fast search and match process.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The invention can be summarized as follows. An apparatus for content item signature matching comprises a database (103) which has signatures for a plurality of content items. A likelihood processor (105) determines a match likelihood indication for the content items where the match likelihood indication is indicative of a likelihood of a match between the content item and an unknown signature. An interface (111) receives a query signature associated with a content item and in response a search processor (113) searches the database (103) for a matching signature to the query signature. The search processor (113) is operable to search the database in response to the match likelihood indication of the plurality of content items. In particular the database (103) may be ordered in order of decreasing probability of a match and the search processor (113) may search the database in this order. Hence, the probability of an early match is increased and the average search time is reduced.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for content item signature matching comprising:
a database (103) comprising signatures for a plurality of content items;
means for determining a match likelihood indication (105) for each of the plurality of content items, the match likelihood indication of each content item being indicative of a likelihood of a match between the content item and an unknown signature;
means for receiving (111) a query signature associated with a content item;
search means (113) for searching the database (103) for a matching signature to the query signature; and
wherein the search means (113) is operable to search the database (103) in response to the match likelihood indication of the plurality of content items.

2. An apparatus as claimed in claim 1 further comprising means for ordering (107) the signatures of the plurality of content items in the database (103) in response to the match likelihood indication; and wherein the search means (113) is operable to search the database (103) in accordance with the ordering of the signatures of the plurality of content items.

3. An apparatus as claimed in claim 1 wherein the means for determining the match likelihood indication (105) is operable to determine the match likelihood indication in response to a previous match count for each signature of at least some of the plurality of content items.

4. An apparatus as claimed in claim 1 wherein the means for determining the match likelihood indication (105) is operable to determine the match likelihood indication in response to a database entry time for each signature of the plurality of content items.

5. An apparatus as claimed in claim 1 wherein the means for determining the match likelihood indication (105) is operable to determine the match likelihood indication in response to a previous time of matching for each signature of the plurality of content items.

6. An apparatus as claimed in claim 1 wherein the means for determining the match likelihood indication (105) is operable to determine the match likelihood indication in response to metadata associated with each of the plurality of content items.

7. An apparatus as claimed in claim 1 wherein the means for determining the match likelihood indication (105) is operable to determine the match likelihood indication in response to context information associated with each of the plurality of content items.

8. An apparatus as claimed in claim 1 wherein the means for determining the match likelihood indication (105) is operable to determine the match likelihood indication in response to content information associated with each of the plurality of content items.

9. An apparatus as claimed in claim 8 further comprising means for determining the content information by content analysis.

10. An apparatus as claimed in claim 1 wherein the match likelihood indication comprises a plurality of sub-match likelihood indications and the search means (113) is operable to search the database hierarchically in response to the sub-match likelihood indications.

11. An apparatus as claimed in claim 1 wherein the match likelihood indication comprises a plurality of sub-match likelihood indications and the search means (113) is operable to select a sub-match likelihood criterion in response to a characteristic of the query signature.

12. An apparatus as claimed in claim 1 wherein the query signature is a content item fingerprint.

13. An apparatus as claimed in claim 12 wherein the matching signature is a matching fingerprint and the search means (113) is operable to determine a matching fingerprint as a fingerprint having a difference measure relative to the query signature below a predetermined value.

14. An apparatus as claimed in claim 1 wherein the content item is an audiovisual content item.

15. An apparatus as claimed in claim 1 wherein the receiving means (111) comprises means for receiving a content item and for determining the content item signature in response to the content item.

16. A method of content item signature matching in a database (103) comprising signatures for a plurality of content items, the method comprising the steps of:
determining a match likelihood indication for each of the plurality of content items, the match likelihood indication of each content item being indicative of a likelihood of a match between the content item and an unknown signature;
receiving a query signature associated with a content item;
searching the database (103) for a matching signature to the query signature in response to the match likelihood indication of the signatures of the plurality of content items.

17. A computer program enabling the carrying out of a method according to claim 16.

18. A record carrier comprising a computer program as claimed in claim 17.
